(19) United States
(12) Patent Application Publication
(10) Pub. No.: US 2009/0207624 A1
(43) Pub. Date: Aug. 20, 2009

(54) HEADLIGHT ASSEMBLY PERMITTING COMPENSATION FOR VISIBILITY CHANGES

(75) Inventors: Cheuk Nam Ma, Hong Kong (CN); Kwok Ming Au, Hong Kong (CN)

Correspondence Address: CROWELL & MORING LLP;INTELLECTUAL PROPERTY GROUP, P.O. BOX 14300, WASHINGTON, DC, 20044-4300, US

(73) Assignee: Acumen, Inc., Sterling, VA (US)

(21) Appl. No.: 12/032,189

(22) Filed: Feb. 15, 2008

(51) Int. Cl. F21V 33/00

(52) U.S. Cl. 362/475

(57) ABSTRACT

In a device including a headlight assembly that outputs a beam of light and a lens housing mountable at a forward end of the headlight assembly, an arrangement, receivable on the lens housing, renders the beam of light adaptable to different weather and lighting conditions. In a preferred form, the arrangement includes a plurality of interchangeable filter elements, such as green, blue, yellow, and red elements, that are alternatively receivable on the lens housing, A wide angle lens could also be included among the interchangeable filter elements. The device as a whole could be provided in the form of a packaged collection of elements adapted for subsequent assembly.

### BACKGROUND OF THE INVENTION

1. Field of the Invention

This invention concerns a device by which compensation for changes in visibility is made available for the headlight of a bicycle or similar vehicle.

2. Description of Related Art

U.S. Pat. No. 6,805,473 to Beard concerns a bicycle light operable to emit light of one color in one direction and light of another color in and opposite direction.

U.S. Pat. No. 5,617,303 to Izzo, Sr. discloses a signaling apparatus for a bicycle having a housing for battery and horn assemblies.

U.S. Pat. No. 4,019,046 to Reynolds relates to a headlight safety cover for a motorcycle that serves to improve visibility of the motorcycle during daylight hours.

U.S. Pat. No. 7,100,932 to Meggiolan and U.S. Patent Application Publication 2005/0056670 A1 to Campagnolo disclose bottle supports and cylindrical battery sheaths mounted on frame tubes of bicycles.

U.S. Pat. No. 6,286,982 to Tashiro concerns a lighting apparatus for a bicycle in which a light emitting unit and a battery case can be demounted for an alternative use.

### SUMMARY OF THE INVENTION

It is one object of the present invention to provide an illumination device that permits simple and readily adjustable compensation for changes in visibility during operation of a bicycle or other vehicle. A device according to the invention, therefore, includes a headlight assembly that outputs a beam of light, a lens housing, for a conventional or wide angle lens, mountable at a forward end of the headlight assembly, and an arrangement that is receivable on the lens housing by which the beam of light is made adaptable to different weather and lighting conditions. In a preferred form, the arrangement includes a plurality of interchangeable filter elements, such as green, blue, yellow, and red elements, that are alternatively receivable on the lens housing. The interchangeable filter elements could also include a wide angle lens.

A mounting strap by which the headlight assembly is mountable to the bicycle may be provided so that, if desired, the headlight assembly can be secured to handlebars of the bicycle.

The headlight assembly, the lens housing, and the arrangement receivable on the lens housing can be provided as a packaged collection of elements adapted for easy transportation and subsequent assembly. A power supply, detachably securable beneath a seat or saddle of the bicycle or on the bicycle frame, can also be provided as part of that collection, along with a harness intended to electrically interconnect the power supply, the headlight assembly, and a remote control.

### BRIEF DESCRIPTION OF THE DRAWING

FIG. 1 is a perspective view of a battery power supply unit forming a part of one configuration of the invention.

FIG. 2 is a longitudinal sectional view of the unit illustrated in FIG. 1.

FIG. 3 is a view, in perspective, of a headlight assembly and a mounting strap by which the headlight assembly can be secured to a bicycle handlebar or other vehicle component.

FIG. 4 is a longitudinal sectional view of the headlight assembly illustrated in FIG. 3.

FIG. 5 is a front view of the headlight assembly and mounting strap shown in FIG. 3.

FIG. 6 is a top view of amounting bracket and adjacent elements by which the headlight assembly is secured.

FIG. 7 is an exploded view, in perspective, of a bicycle housing element, a mounting bracket, and the mounting strap with a knob assembly at its end.

FIG. 8 is a sectional view of the elements illustrated in FIG. 7 in an assembled condition.

FIG. 9 is a front view of the assembly shown in FIG. 8.

FIG. 10 is a side view of the assembly shown in FIG. 9.

FIG. 11 is a view similar to that of FIG. 9, but in the opposite direction and partly in section.

FIG. 12 is a view of the headlight assembly along with a clear wide angle lens or filter and various colored filters that are interchangeable with the clear filter.

FIG. 13 is a view of a harness designed to extend between an end cap of a power supply unit and the jack of a headlight assembly.

FIG. 14 shows a dual headlight assembly useable in place of the single headlight assembly.

FIG. 15 illustrates the power supply unit of FIGS. 1 and 2 installed on a bicycle frame.

FIG. 16 shows a different power supply unit mounted in an alternative position on a bicycle.

FIG. 17 is a view similar to that of FIG. 13 but of a harness designed for use with the power supply unit of FIG. 16.

### DETAILED DESCRIPTION OF THE INVENTION

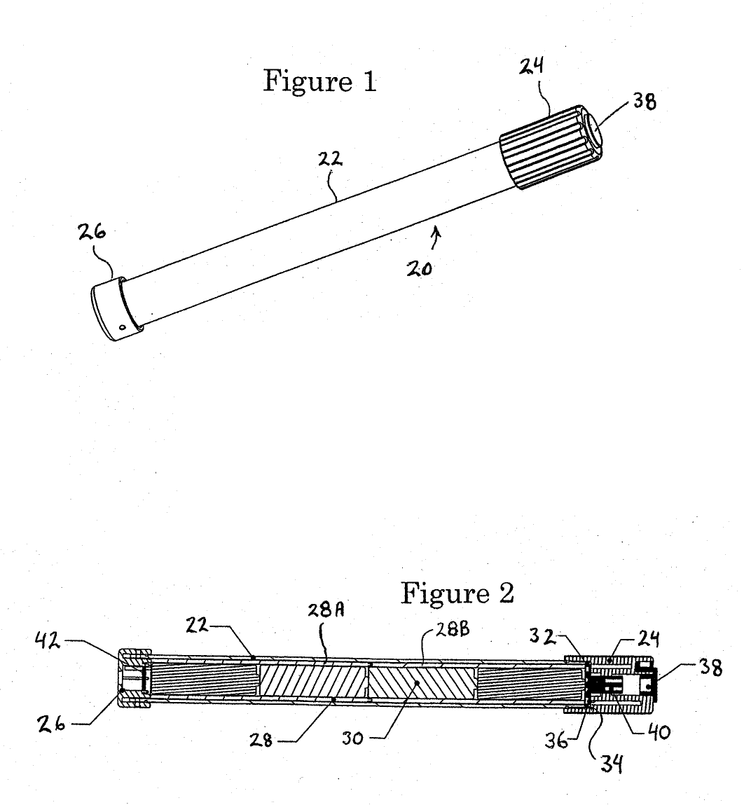

FIG. 1 provides a perspective view of one configuration of a battery power supply unit 20 forming a part of a first configuration of an illumination device or system. This illumination device or system will occasionally be referred to in the following description as the NANO-LUX system. The NANO-LUX system has two configurations; one of these configurations is a single headlight configuration, while the other configuration is a double or dual headlight configuration.

The power supply unit 20, as illustrated, includes a cylindrical aluminum tube 22 (the NANO-TUBE assembly), forming a lightweight and attractive outer skin, that is open at both ends, a battery jack holder 24 secured to a first of the tube ends, and an end cap 26 secured to a second of the tube ends located opposite the first end. The holder 24 may be connected by threads to the first tube end for easy removal and replacement, and the end cap 26 may also be connected by threads to the second tube end. The jack holder 24 or the end cap 26 could be bonded, glued, or otherwise secured to its respective tube end rather than connected by threads. Snap fit connections or other connection types are also useable. The cross sectional view provided by FIG. 2 also shows the holder 24 and the end cap 26 at opposite ends of the tube 22.

FIG. 2 further illustrates a battery tube 28 received within the outer aluminum tube 22. To facilitate assembly, the battery tube can be constructed from multiple tube parts, such as the parts 28A, 28B shown. The battery tube 28 and other power supply unit parts, as illustrated, are designed and dimensioned to receive four serially arranged AA batteries 30, although other configurations are possible.

In its assembled condition, the power supply unit 20 has a printed circuit board (PCB) plate 32 interposed between a radially inwardly projecting shoulder 34 of the battery jack holder 24 and the adjacent first tube end. A brass connect ring (not indicated) is also located at the first tube end. The PCB plate 32 supports a jack PCB 36 as well as a jack 40, provided in a socket adapted to receive a mating plug (not shown in FIG. 2) of a wire or cable. This wire or cable may lead to an appropriate tail light (or the headlight, if desired), enabling power to be supplied to the tail light (or the headlight) by the unit 20. Preferably, a rubber plug 38 encloses the socket when the wire or cable is not used in order to prevent contamination of the socket by dirt, water, and so on.

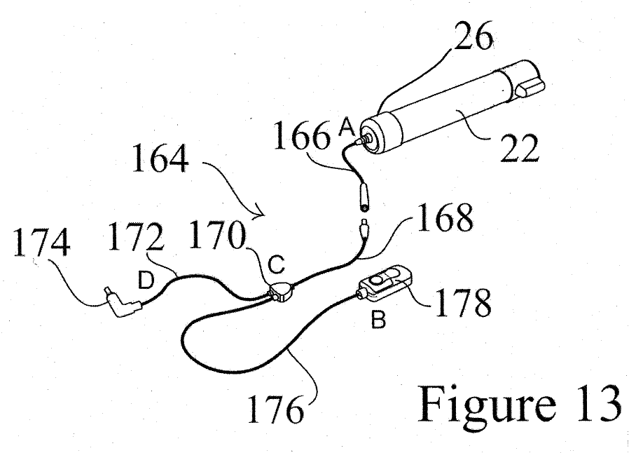

In the configuration shown, the end cap 26 supports a PCB 42 by which the batteries 30 are connected to a harness cord exiting the end cap 26, as will be described below. An electrical conductor such as the harness cord 166 shown in FIG. 13 may be used as an interconnecting element.

In one preferred configuration, the battery jack holder 24, the end cap 26, the battery tube 28, and the PCB plate 32 are formed of a common thermoplastic material such as acrylonitrile butadiene styrene (ABS). The PCBs 36 and 42 may be of a woven glass and epoxy prepreg type, such as FR4 D/S.

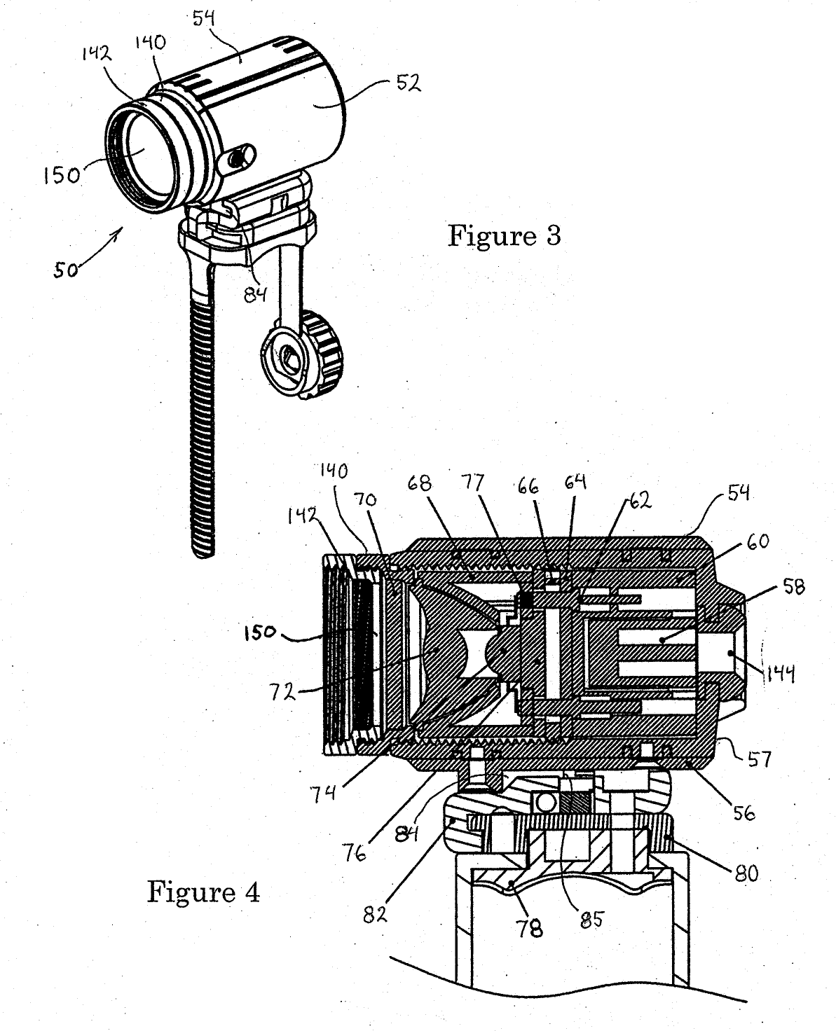

The headlight assembly 50 shown in perspective in FIG. 3 includes an aluminum case 52 with spaces or channels within which a decorative insert 54 and a light holder 56 can be fixed by snap connections, screws, or the like. The case 52, the insert 54, and the light holder 56 are secured by the screws, the snaps, or other connections to a cylindrical headlight housing 57. Various conventional components are received within the housing 57. These components are best seen in the cross sectional view provided by FIG. 4, and include a jack 58, which may be brass, an ABS jack holder 60, a brass/nickel connect pin 62, an ABS pin cover 64, an aluminum screw element 66, an ABS lens holder 68, a clear lens 72, a light emitting diode or similar light source 74, an aluminum radiator 76, and a FR4 D/S PCB 77. Another clear lens 70 is located at a front end of the headlight assembly 50.

A first lens housing 140, within which the lens 70 is mounted, is threadedly received within a forward end of the cylindrical housing 57. A second lens housing 142, within which a wide angle lens 150 (FIG. 3) is mountable, for example, is threadedly receivable within the forward end of the first lens housing 140. For reasons that will become apparent, the second lens housing 142 will also be referred to below as a “clear filter” housing. By way of the threaded connection between the clear filter housing 142 and the first lens housing 140, the interchangeable wide angle lens 150, which converts the narrow beam of light traveling from the light source 74 through the clear lenses 70 and 72 into a wide angle beam, can be mounted in position at the forward end of the headlight assembly 50. A receptacle 144 is located at a rearward end of the cylindrical headlight housing 57 in order to receive the jack connector of a harness extending, for example, between the jack 40 of the power supply unit 20 and the jack 58 of the headlight assembly 50.

Also visible in FIG. 4 are certain other components, such as a bicycle grip or holder 78, having an appropriate contour, a bicycle housing element 80, and a mounting bracket 82, which are all secured together and which cooperate in a manner to be described to mount and retain the headlight assembly 50 in position on bicycle handlebars or other tubular components. Additional description of these elements is presented below. With minimal modification to the grip holder 78, the headlight assembly could also be mounted on a handlebar stem.

The mounting bracket 82 defines a recurved, hook-shaped protrusion 90 at one end, as illustrated in FIGS. 6-8. To secure the mounting bracket 82 to the bicycle housing element 80, the protrusion 90 is hooked around a flange 92 projecting from a front end of the housing element 80, pivoted into position, and secured by an appropriate fastener, such as a screw (not shown) receivable in a bore 94 extending through the mounting bracket 82 and the housing element 90 and into the grip or holder 78. A set screw or positioning pin 96 can facilitate alignment of the bracket 82 and the housing element 80.

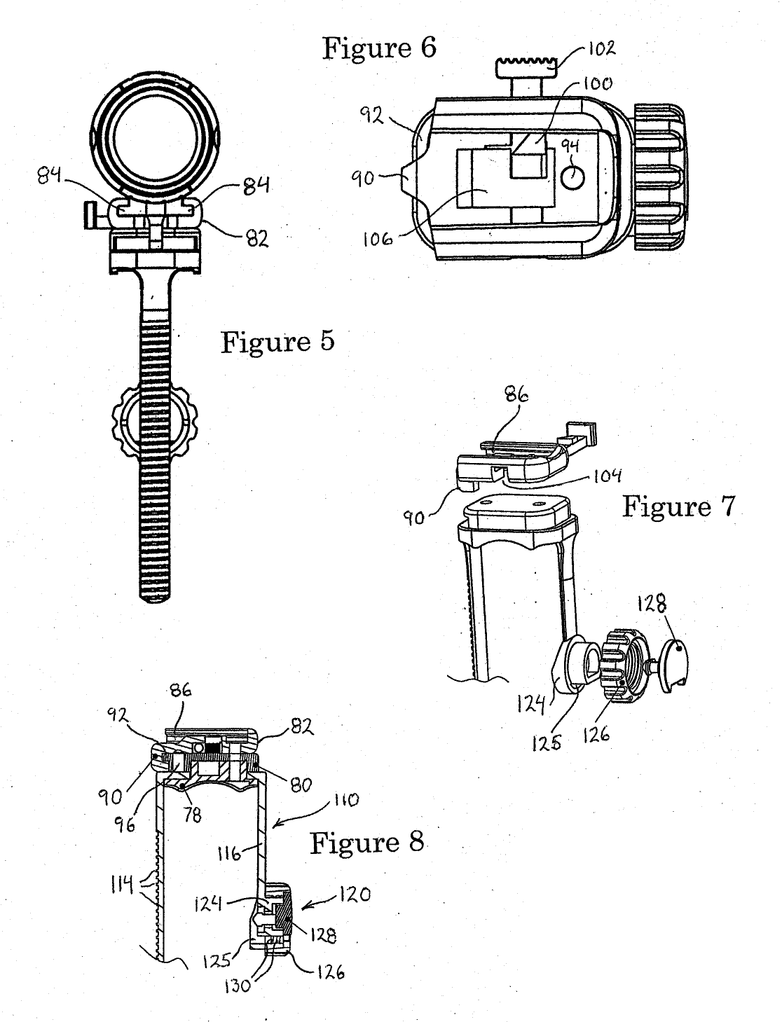

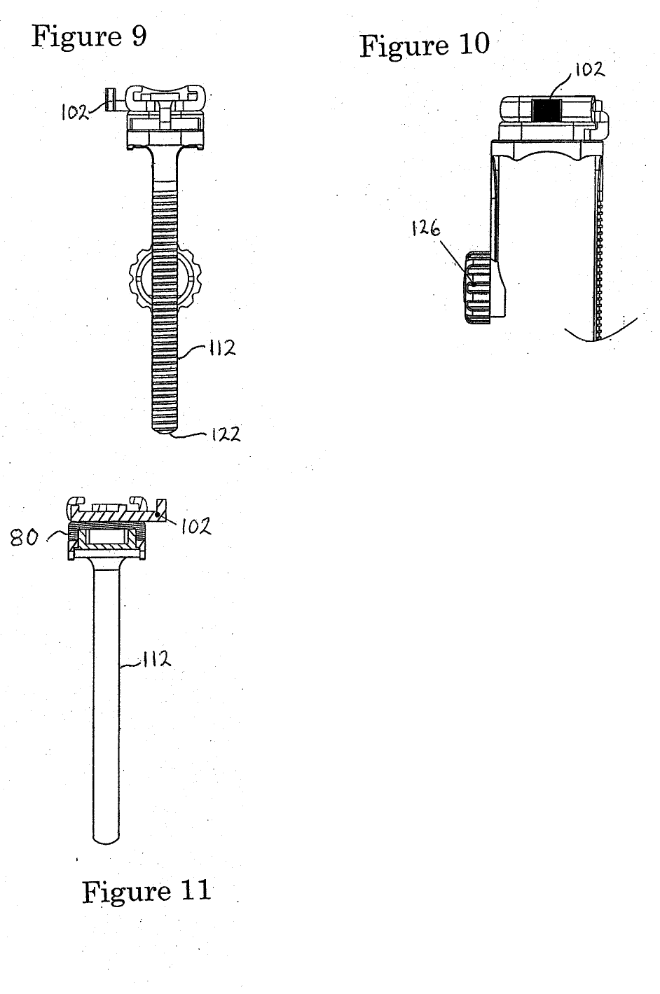

As shown in FIGS. 3 and 5, the light holder 56 defines oppositely extending flanges 84 at its forward portion. These flanges are slidable into and out of grooves 86 defined in the mounting bracket 82. The grooves 86 are visible, for example, in FIGS. 7 and 8. Once the flanges 84 are inserted into the grooves 86, the headlight assembly 50 as a whole can be moved rearward relative to the mounting bracket 82 until a back edge 85 of one of the flanges 84 engages with a cam 100 defined on a release pin 102, which is movable transversely in appropriate holes or recesses 104 provided in the mounting bracket 82. Lateral edges of an upstanding central portion 106 defined on the mounting bracket 82 serve to guide movement of the headlight assembly 50 by engagement with inner surfaces of the flanges 84. After engagement between the appropriate flange 84 and the cam 100, the headlight assembly 50 is retained in position, inter alia, by frictional engagement between the flanges 84 and the grooves 86.

The release pin 102 assists a user in disengaging the headlight assembly 50 from the mounting bracket 82. The cam 100 is shaped so that transverse movement of the release pin 102 in an appropriate direction, by being pressed or pulled by a user, at least partially ejects the flanges 84 from the grooves 86 to provide at least partial disengagement of the assembly 50 and bracket 82. Full disengagement may then be completed manually.

A mounting strap 110 is clamped or otherwise retained between adjacent surfaces of the bicycle housing element 80 and the grip or holder 78. The mounting strap 110 is formed of an appropriate elastic material, and, in a conventional manner, can be wrapped around a bicycle handlebar or other tubular component to secure the grip or holder 78 in position.

The mounting strap 110 includes a forward strap portion 112 with teeth 114 defined thereon and a rearward strap portion 116 terminating in a knob assembly 120. The knob assembly 120 includes a central knob mount 124 defined at or secured to the end of the rearward strap portion 116, a rotatable knob 126, and a locket 128 by which the rotatable knob 126 is secured but permitted to rotate relative to the central knob mount 124. When wrapping the strap 110 around the bicycle handlebar, a user inserts an end 122 of the forward strap portion 112 into a slot 125 extending through the knob assembly 120. Threads 130 defined on a circumferential interior of the knob 126 are receivable in the spaces defined between the teeth 114 on the strap portion 116 so that, by rotation of the knob 126, the mounting strap 110 can be tightened around or released from the bicycle handlebar or other tubular element.

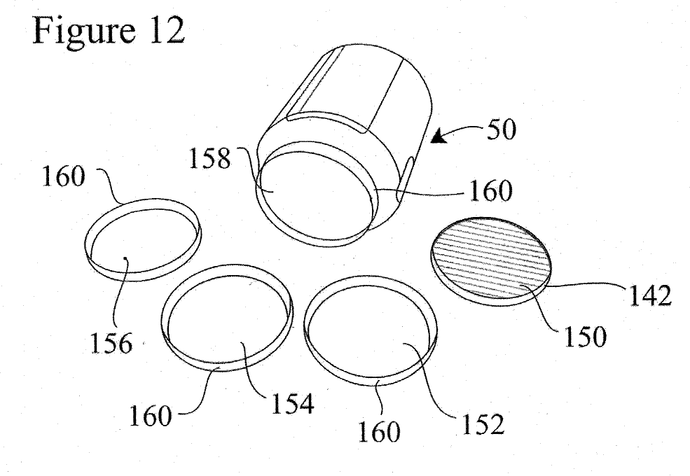

FIG. 12 illustrates the headlight assembly 50 along with the wide angle lens 150, forming a clear “filter” or “filter element,” and various color filters or filter elements 152, 154, 156, and 158, which are interchangeable or useable in combination with the wide angle lens 150 for use in different environments and under different weather conditions. By way of example, the filter 152 may be green, the filter 154 may be blue, the filter 156 may be yellow, and the filter 158 may be red. Each of the filters includes a housing 160 having essentially the same construction as that of the clear filter housing 142. Any of the filter housings is threadedly receivable within the forward end of the first lens housing 140 (FIG. 4) in the same way as the second lens housing 142. The wide angle lens and various filters can also be attached in series to combine the effects. For example, the clear filter housing 142 can be connected to the first lens housing 140 as shown in FIG. 4, and the housing 160 of another filter, such as the green filter 152, can be connected, by cooperating threads, to the forward end of the clear filter housing 142. Of course, it is also possible to reverse this order, so that an appropriate filter housing 160 is directly connected to the first lens housing 140, and the clear filter housing 142 is connected to the filter housing 160. The wide angle lens and/or the filters may alternatively be retained in place frictionally or in other appropriate ways, such as by threads or by snap connections, on the appropriate outer circumferential surface.

FIG. 13 shows a harness, generally designated 164, that is designed to extend between the end cap 26 of the power supply unit 20 and the jack 58 of the headlight assembly 50. Although other configurations are conceivable, the harness illustrated includes a first cord 166 exiting the end cap 26 secured to the cylindrical tube 22 of the power supply unit, a second cord 168 detachable from the first cord and extending from a connection with the first cord 166 to a junction 170, a third cord 172 extending from the junction 170 to a jack connector 174 receivable within the receptacle 144 of the headlight housing 57 so as to electrically interconnect the harness and the power supply unit to the jack 58, and a fourth cord 176 extending from the junction 170 to a remote control 178 operable by a user. Approximate dimensions of the harness 164 are 50 cm total for cords 166 and 168, 9.5 cm for cord 176, and 17 cm for cord 172.

For a single headlight configuration such as the headlight assembly 50, a three watt solid state emitter, with high/low intensity, is utilized. The emitter is built as a plug and play module for easy replacement, and the assembly 50 is configured as a miniature headlight structure with minimum diameter and length. An aluminum casing is utilized for high-efficiency heat dissipation, and, although variations are possible, it is contemplated that the interchangeable lenses would include four colored filters, namely yellow, AC red, blue, and green, and one wide angle lens that converts a narrow beam to a wide beam as described above. Operation of the remote control 178, in the single headlight configuration, is OFF→High→OFF→Low→OFF. This operation can provide the high/low intensity with an improved, more visual distinction. The quick release bicycle mount preferably has a swivel angle of ±15 degrees, and the tilt angle is based on the mounting angle. A red LED indicator on the remote control unit may be used to signal low battery power. The power supply unit 20 (the NANO-TUBE assembly), again, uses four AA batteries, arranged serially. As described below, the power supply unit 20 is intended for installation on a bicycle frame beside s water bottle by way of a quick release bracket that shares the water bottle braze-ons.

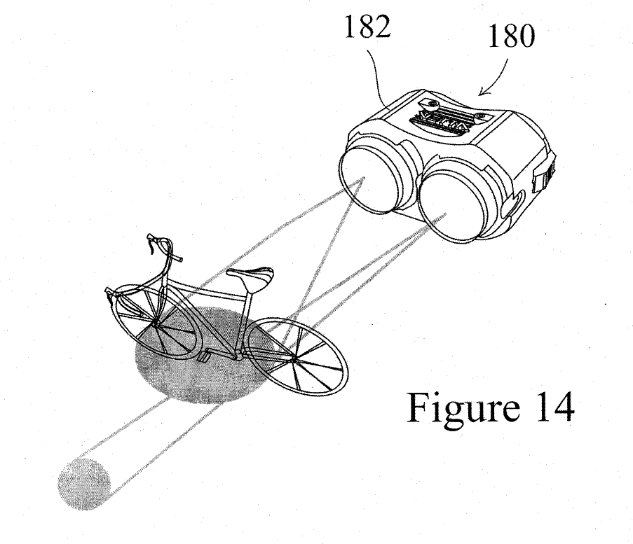

FIG. 14 shows a dual headlight assembly 180 useable in place of the single headlight assembly 50 described previously and constituting part of a second NANO-LUX system configuration. The dual headlight assembly 180 (the NANO-PACK assembly) is configured as a pair of single headlight assemblies, each similar to the assembly 50, mounted together in a unitary housing 182 that is provided with a jack similar to the jack 58 of the assembly 50. In one preferred configuration, the dual headlight assembly 180 includes a three watt solid state emitter in the left headlight and a one watt solid state emitter in right headlight. All emitters are built as a plug-and-play module for easy replacement. As in the single headlight assembly described previously, the headlight assembly 180 has a miniature structure with minimum diameter and length, the casing is aluminum for high efficiency heat dissipation, and, for each of the pair of headlights, interchangeable lenses, including a multiplicity of colored filters, such as yellow, AC red, blue, and green, and a clear filter, or wide angle lens, that converts a narrow beam to a wide beam, are provided. Operation of the remote control is OFF→Right→Left→Dual→OFF, and the left headlight is a three watt high beam, while the right headlight is a one watt low beam. When either the single headlight assembly 50 or the dual headlight assembly 180 is to be mounted on a helmet, a one-to-one power cord with an extended length can be used. The headlights in the dual light assembly can have different filters attached to the low and high beam lights. For example, the left, high beam headlight could have a red filter mounted to it, while the right, lower beam headlight could have a clear filter, i.e. a wide angle lens, mounted to it.

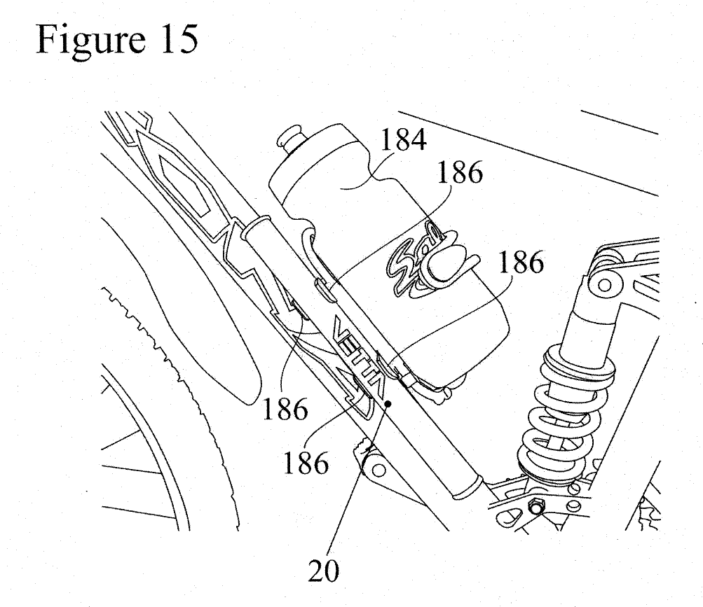

As described, the power supply unit 20 preferably utilizes four AA batteries, arranged serially. The unit 20 is preferably part of a standard package of components including the single headlight assembly 50, but is also compatible with the dual headlight assembly 180. Referring to FIG. 15, in its preferred configuration, the power supply unit 20 is installed on a bicycle frame, beside a water bottle 184, with a quick release bracket that shares the same water bottle braze-ons, such as a bracket including clips (such as C-clips) or clasps 186. VELCRO connection elements could additionally or alternatively be used. The jack 40 of the power supply unit 20 (FIG. 2), again, defines a socket adapted to receive a mating plug (not shown) of a wire or cable leading to an appropriate tail light.

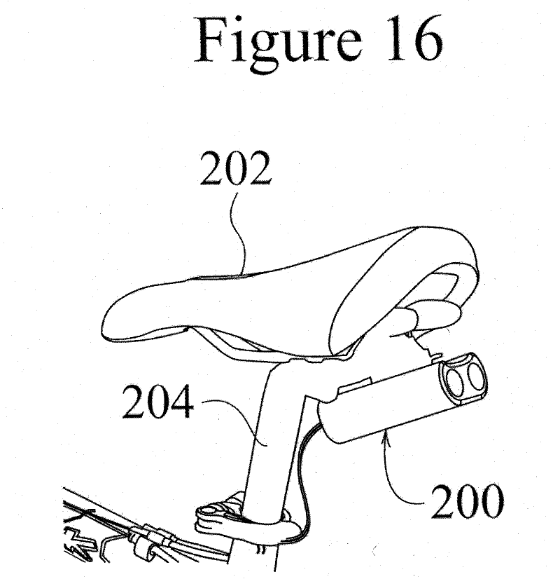

FIG. 16 shows an alternative power supply unit 200 mounted in an alternative position on a bicycle. The power supply unit 200 preferably uses four C batteries, is part of a standard package of components including the dual headlight assembly 180, and is also compatible with the single headlight assembly 50. The unit 200 is preferably installed under the bicycle saddle 202 and makes use of a conventional quick release bracket and configuration of a saddlebag. A bracket including clips, such as C-clips, or clasps, for example, could be used. Again, VELCRO connection elements could additionally or alternatively be used. The unit 200, otherwise, could be contained in a pouch that is securable to the seat post 204 or the top tube of the bicycle frame, for example.

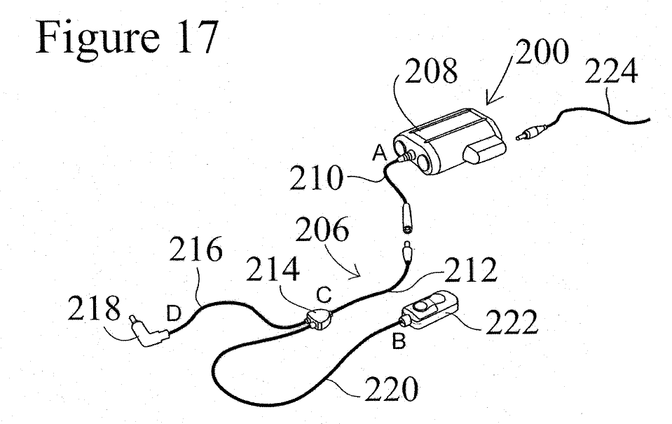

FIG. 17 shows a harness, generally designated 206, that is designed to extend between a jack of the power supply unit 200 and either the jack 58 of the headlight assembly 50 or the analogous jack (not shown) of the dual headlight assembly 180. The harness illustrated in FIG. 17 includes a first cord 210 exiting an end cap 208 of the power supply unit 200, a second cord 212 detachable from the first cord and extending from a connection with the first gord 210 to a junction 214, a third cord 216 extending from the junction 214 to a jack connector 218, receivable either within the receptacle 144 of the headlight housing 57 or within a corresponding receptacle of a housing of the unit 200, so as to electrically interconnect the harness and the power supply unit to the appropriate headlight assembly jack, and a fourth cord 220 extending from the junction 214 to a remote control 222 operable by a user. Approximate dimensions of the harness 206 are 50 cm total for cords 210 and 212, 9.5 cm for cord 220, and 17 cm for cord 216. An additional cord 224, attachable to a rear jack of the power supply unit 200, is illustrated in FIG. 17. Such an additional cord 224 can be used to interconnect the unit 200 to an appropriate tail light, enabling power to be supplied to the tail light.

The various filters as described serve to provide a new cosmetic for both single and dual headlight configurations. As noted, the NANO LUX series or system includes a first model, which is the single headlight system described, and a second model, which is the dual headlight system described. Each headlight can accommodate interchangeable color filters for different weather and environments, as well as an interchangeable wide-angle lens to convert a narrow beam to a wide-angle beam. Each configuration described utilizes a miniature headlight structure for an already crowded handlebar that is lightweight, permitting installation on a helmet as well as at locations such as on handlebars.

In the dual headlight configuration, a pitched dual beam is provided, with the left and right headlights pitched 5° for better road coverage. In a preferred configuration, again, the left headlight is a high beam light with a three watt solid state emitter, and the right headlight is a low beam light with a one watt solid state emitter.

The power supply unit 20 (the NANO-TUBE configuration), again, is one of a number of standard parts for the single headlight arrangement, but it is to be recognized that the unit 20 is also compatible with the dual headlight arrangement. The unit 20 has a diameter of approximately 15 mm, uses four standard AA batteries as described, and, again, is preferably installed beside the water bottle with a quick release bracket that shares the water bottle braze-ons. The alternative power supply unit 200 (the NANO-PACK configuration) is one of a number of standard parts for the dual headlight arrangement, but the unit 200 is also compatible with the single headlight arrangement. As described, the NANO-PACK power supply unit 200 uses four standard C-cell batteries.

Certain functions and features of the single headlight configuration that are to be particularly noted will be reiterated here. The single headlight configuration includes a three watt solid state emitter, with high/low intensity. The emitter is built as a plug and play module for easy replacement, and the headlight has a miniature structure, with minimum diameter and length. An aluminum casing is used in order to provide high-efficiency heat dissipation. The interchangeable lenses include four colored filters, namely yellow, AC red, blue, and green. A wide angle lens that converts a narrow beam to a wide beam is also provided. The OFF→High→OFF→Low→OFF sequence by which the remote control 178 is operated assists in providing the high/low intensity with more visual distinction.

The quick release bicycle mount provided by the bicycle grip or holder 78, the bicycle housing element 80, and the mounting bracket 82 has a tilt or swivel angle of approximately ±15 degrees based, of course, on the mounting angle. A red LED indicator on the remote control unit may be used to signal low battery power. The power supply unit 20 is installed beside the water bottle, by way of clips, for example, that form a quick release bracket sharing water bottle braze-ons. A rear socket defined in the power supply unit 20 permits a tail light power supply.

In its preferred configuration, the quick release headlight bike mount has a ±15 degree swivel angle, as does the quick release helmet mount. In its preferred configuration, the quick release bracket for the NANO-TUBE has two long bolts and one Velcro element.

In one preferred configuration, the left headlight of the double headlight arrangement is a three watt high beam, while the right headlight is a one watt low beam. The swivel angle of the quick release bicycle mount is ±15 degrees, and the tilt angle is based on the mounting angle, with the low beam is pitched −5 degrees with respect to the high beam. Two interchangeable filters sets, each having four colors, namely yellow, AC red, blue, and green, are provided for the double headlight arrangement. Two interchangeable wide-angled lenses are also provided, and a quick-release battery bracket, which is the same as that for the saddle bag, is installed under the saddle.

The foregoing disclosure has been set forth merely to illustrate the invention and is not intended to be limiting. Since modifications to the disclosed embodiments incorporating the spirit and substance of the invention may occur to persons of ordinary skill in the art, the invention should be construed to include everything within the scope of the appended claims and equivalents thereof.

1. A device that provides illumination and permits compensation for changes in visibility during operation of a vehicle, comprising:
a headlight assembly that outputs a beam of light,
a lens housing mountable at a forward end of the headlight assembly, and
an arrangement that is receivable on the lens housing by which said beam of light is made adaptable to different weather and lighting conditions.

2. The device of claim 1, wherein said arrangement includes a plurality of interchangeable elements that are alternatively receivable on said lens housing.

3. The device of claim 2, wherein said interchangeable elements are filters.

4. The device of claim 3, wherein said filters include green, blue, yellow, and red filters.

5. The device of claim 3, wherein at least one of said filters is a wide angle lens.

6. The device of claim 1, wherein said headlight assembly is one of a pair of headlight assemblies mounted together in a unitary housing.

7. The device of claim 1, wherein the arrangement includes a plurality of interchangeable elements selectively receivable in series on the lens housing.

8. The device of claim 7, wherein each of the interchangeable elements is threadedly securable within a forward end of the lens housing.

9. The device of claim 1, wherein the vehicle is a bicycle.

10. The device of claim 9, further comprising a mounting strap by which the headlight assembly is mountable to the bicycle.

11. The device of claim 10, wherein the headlight assembly is mountable to handlebars of the bicycle.

12. The device of claim 9, further comprising a power supply detachably securable to the bicycle.

13. The device of claim 12, wherein the power supply is mountable beneath a saddle of the bicycle.

14. The device of claim 12, wherein the power supply is mountable on a frame of the bicycle.

15. The device of claim 12, further comprising a user operable remote control, and a harness electrically interconnecting the power supply, the headlight assembly, and the remote control.

16. The device of claim 1, wherein the headlight assembly, the lens housing, and the arrangement receivable on the lens housing form a packaged collection of elements adapted for subsequent assembly.

17. The device of claim 10, wherein the headlight assembly is mountable to a handlebar stem of the bicycle.

18. The device of claim 6, wherein each of said pair of headlight assemblies has at least one filter mounted at its forward end.

19. A device that provides illumination and permits compensation for changes in visibility during operation of a bicycle, comprising:
a headlight assembly that outputs a beam of light,
a lens housing mountable at a forward end of the headlight assembly, and
exchangeable means receivable on the lens housing for adjusting said beam of light to different weather and lighting conditions.

20. The device of claim 19, wherein said exchangeable means is any of a plurality of interchangeable filter elements.

21. The device of claim 20, wherein said filter elements include green, blue, yellow, and red filter elements.

22. The device of claim 21, wherein at least one of said filter element is a wide angle lens.
